(19) United States
(12) Patent Application Publication
(10) Pub. No.: US 2012/0312654 A1
(43) Pub. Date: Dec. 13, 2012

(54) DOUBLE CLUTCH FOR VEHICLE COMPRESSOR

(76) Inventor: Hyeoungpal Kim, Paju-si (KR)

(21) Appl. No.: 13/580,147

(22) PCT Filed: Jan. 26, 2011
(86) PCT No.: PCT/KR11/00540

§ 371 Date: Aug. 20, 2012

(30) Foreign Application Priority Data
Feb. 22, 2010 (KR) 10-2010-0015659

(51) Int. Cl. F16D 27/04

(52) U.S. Cl. 192/48.2

(57) ABSTRACT

The present invention relates to a double clutch for a vehicle compressor for driving a compressor using the power of an engine when a vehicle is being driven, and using the power of a motor when the vehicle is stopped. More specifically, the double clutch for a vehicle compressor, comprises: a rotation shaft axially coupled with the compressor; a plate spring coupled on the rotation shaft; first and second rotation discs coupled in front of and behind the plate spring; a first electromagnet fixed to the compressor; a first pulley positioned between the first rotation disc and the first electromagnet; a fixed disc mounted on the rotation shaft at the side of the second rotation disc; a second electromagnet coupled with the fixed disc; and a second pulley positioned between the second rotation disc and the second electromagnet. The invention enables an air conditioner system to be operated by means of a single compressor using the engine and the motor by connecting the first and second pulleys to respective pulleys on the side of the engine and on the side of the motor, with respective belts. Furthermore, the invention can improve the structure of the vehicle and the air conditioner system and reduce the manufacturing costs thereof.

### TECHNICAL FIELD

The present invention relates to a double clutch for a vehicle compressor which is directed to driving a compressor with the aid of a driving force of an engine when a vehicle runs, and is directed to driving a compressor with the aid of a driving force of a motor when a vehicle is stopped.

### BACKGROUND ART

An air conditioner system of a vehicle generally consists of a compressor, a condenser, an expansion valve and an evaporator like other types of air conditioner systems, among which the compressor is generally is driven by means of a driving force of an engine.

Since the air conditioner system of a vehicle can be driven only when an engine is driven, it is needed to keep the vehicle driven for the purpose of enabling a cooling operation of a vehicle even when a vehicle is stopped for a long time.

In order to improve the above mentioned problems, the U.S. Pat. No. 0,816,770 discloses a technology which is characterized in providing a motor driven by means of an externally supplied electric power and an auxiliary compressor driven by means of the above motor, as such to keep operating the air conditioner system even when the engine of a vehicle is stopped.

In the above mentioned technology, since a compressor driven by means of an engine and an auxiliary compressor driven by means of a motor are installed, two compressors are necessarily needed.

In addition, when the air conditioner system is driven with two compressors being installed, a certain valve, a switch or a pipe is necessarily needed to keep one compressor being connected while the other compressor is disconnected.

### DISCLOSURE OF INVENTION

Accordingly, it is an object of the present invention to provide a double clutch for a vehicle compressor which improves the problems is encountered in a conventional art in which an auxiliary compressor is further needed together with a compressor connected with an engine in order to drive an air conditioner system with the aid of a motor in a state that an engine is stopped.

It is another object of the present invention to provide a double cutch for a vehicle compressor which improves the problems encountered in a conventional art in which a valve, a switch or a pipe is needed for circulating refrigerant by selectively connecting two compressors in terms of an air conditioner system with two compressors.

The double cutch for a vehicle compressor according to the present invention comprises a rotary shaft which is axially engaged to a compressor; a plate spring which is engaged on the rotary shaft and is bent in forward and backward directions; first and second rotation disks which are engaged to the front side and the rear side of the plate spring and have magnetized force; a first electromagnet which is positioned at the side of the first rotation disk and is fixed at the compressor; a first pulley which is positioned between the first rotation disk and the first electromagnet and is installed on the rotary shaft by way of a first bearing and has a first belt groove at an outer rim surface covering the first electromagnet; a fixing disk which is positioned at the side of the second rotation disk and is installed on the rotary shaft by way of a second is bearing; a second electromagnet which is positioned at the side of the second rotation disk and is engaged to the fixing disk; and a second pulley which is positioned between the second rotation disk and the second electromagnet and is installed on the rotary shaft by way of a third bearing and has a second belt groove at an outer rim surface covering the second electromagnet.

An interval of 0.01˜1.8 mm is formed between the surfaces contacting with the first rotation disk and the first pulley and between the surfaces contacting with the second rotation disk and the second pulley.

### ADVANTAGEOUS EFFECTS

According to the present invention, it is possible to drive an air conditioner system with an engine and a motor with the aid of one compressor in such a way to selectively make a driving force be transferred from an engine or a motor by providing a double clutch with a compressor.

The present invention is directed to saving a manufacture cost and an operation cost of an air conditioner by improving the structure of a vehicle and an air conditioner system since the operations of an air conditioner system using an engine and a motor are made possible using one compressor.

### BRIEF DESCRIPTION OF DRAWINGS

FIG. 1 is a front view of a connection structure of a double clutch for a vehicle compressor according to the present invention.

FIG. 2 is a side view illustrating a connection structure of a double clutch for a vehicle compressor according to the present invention.

FIG. 3 is a perspective view illustrating a double clutch for a vehicle compressor according to the present invention.

FIG. 4 is a disassembled perspective view illustrating a double clutch for a vehicle compressor according to the present invention.

FIG. 5 is a cross sectional view illustrating a double clutch for a vehicle compressor according to the present invention.

FIG. 6 is an operation view illustrating a connection state between a double clutch for a vehicle compressor and an engine according to the present invention.

FIG. 7 is an operation view illustrating a connection state between a double clutch for a vehicle compressor and a motor according to the present to invention.

### BEST MODES FOR CARRYING OUT THE INVENTION

The preferred embodiments of the present invention will be described with reference to the accompanying drawings.

The present invention is directed to a technology for the purpose of driving an air conditioner system of a vehicle in such a way to drive a motor 30 with an externally supplied electric power in a state that a vehicle is stopped, and the operation of an engine 20 is stopped like the U.S. Pat. No. 0,816,770.

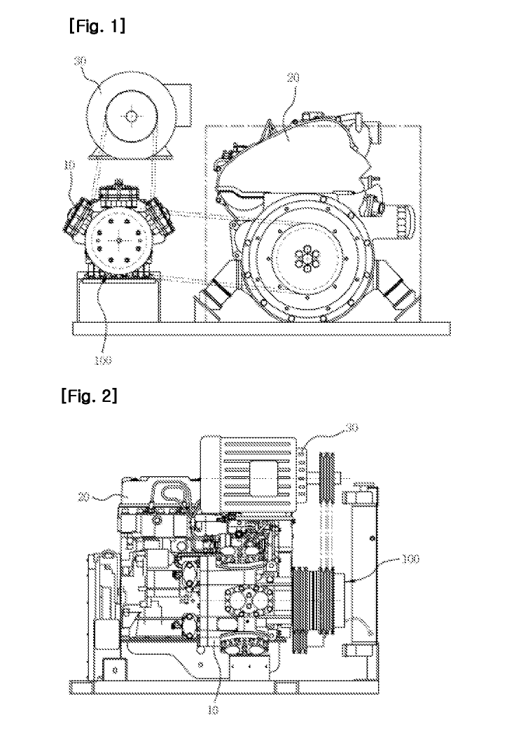

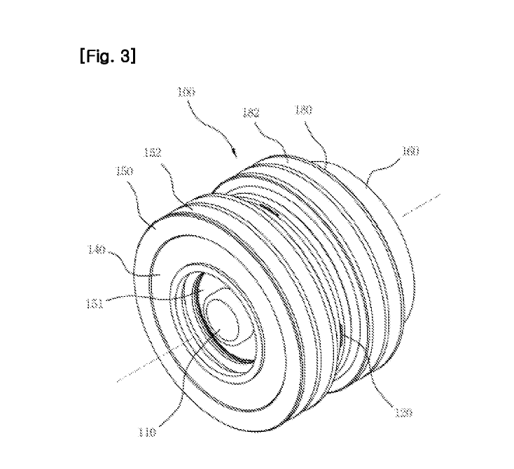

As shown in FIGS. 1 to 7, the double clutch 100 for a vehicle compressor according to the present invention comprises a rotary shaft 110 axially engaged to a compressor 10, a plate spring 120 engaged at the rotary shaft, first and second rotation disks 130a and 130b engaged at the front and read sides of the plate spring, a first electromagnet 140 fixed at the compressor, a first pulley 150 positioned at the first rotation disk and the first electromagnet, respectively, a fixing disk 160 installed at the rotary shaft at the side of the second rotation disk, a second electromagnet 170 engaged at the fixing disk and a second pulley 180 disposed between the second rotation disk and the to second electromagnet.

In other words, the double clutch 100 for a vehicle compressor is characterized in that the pulley at the side of the engine 20 of the vehicle and the pulley at the side of the motor 30 are connected by way of a belt in a state that it is axially engaged to the compressor 10 of the air conditioner system of a vehicle, and the compressor 10 is driven using one driving force from either the engine 20 or the motor 30 with the aid of the operations of the first and second electromagnets 140 and 170.

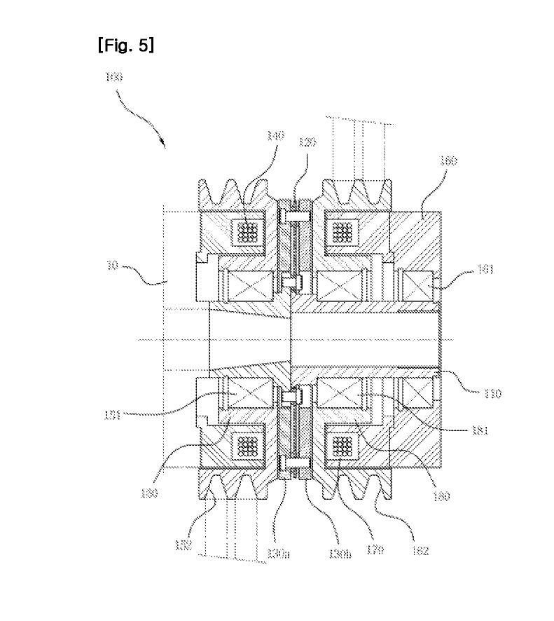

The rotary shaft 110 is configured to be axially engaged to the compressor 10. As an example of the compressor 110, as shown in FIG. 5, there is provided an engaging part at its central portion for the purpose of being fixedly inserted into the shaft of the compressor, and it can be connected to the end of the shaft of the compressor 10 with the aid of an additional coupling.

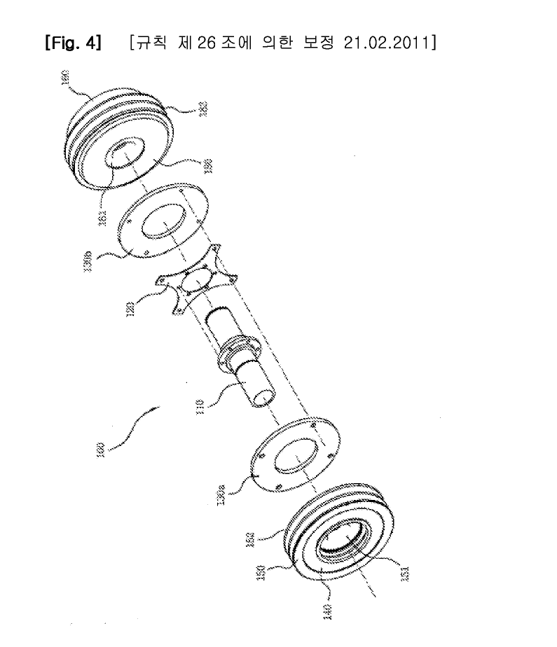

The plate spring 120 is configured to being engaged to the center of the rotary shaft and is formed in a plate shape having a certain electricity coefficient high enough to be bendable in forward and backward directions. At this time, as shown in FIG. 4, the plate spring 120 is configured to have a center which passes through in order for the rotary shaft 110 to be inserted into it, and its peripheral portions are protruded for the purpose of being engaged with the first and second rotation disks 130a and 130b.

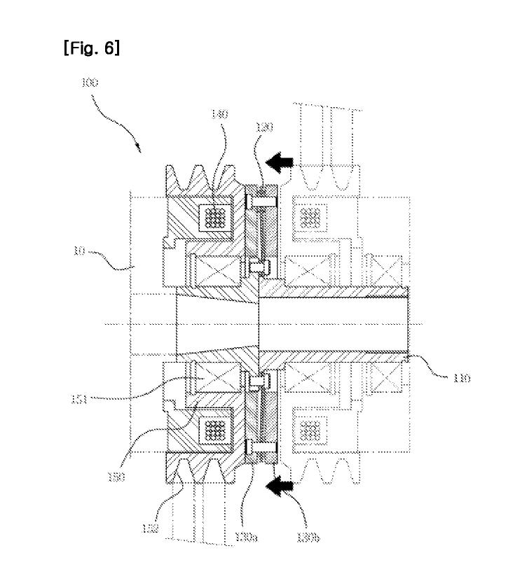

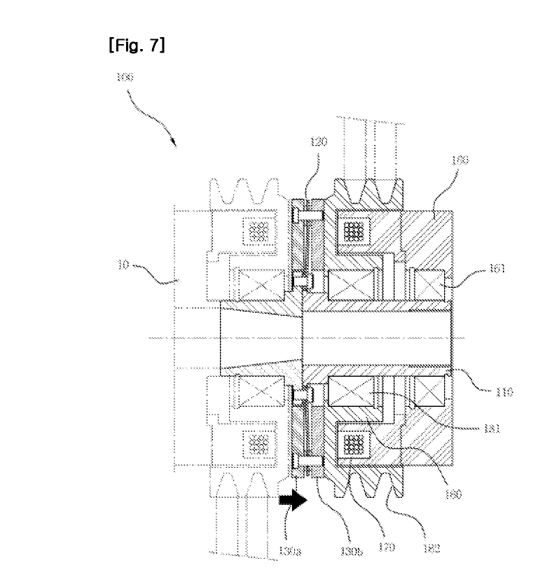

As shown in FIG. 5, the plate spring 120 is positioned at the intermediate portion between the first and second electromagnets 140 and 170, and as shown in FIG. 6 or 7, when either the first electromagnet 140 or the is second electromagnet 170 has a magnetized force, either the first rotation disk 130a or the second rotation disk 130b facing the same is attracted by means of an attractive force and is bent.

The first and second rotation disks 130a and 130b are engaged at the front and rear sides of the plate spring 120 and are made of a metallic material which has a magnetized force. The first and second rotation disks 130a and 130b are configured to have the same shapes and same masses for the plate spring 120 to be balanced at the center.

The first electromagnet 140 is positioned at the side of the first rotation disk 130a and is fixed at the compressor 10. Since a cable is connected to the first electromagnet 140 for the purpose of supplying electric power to it, it should not rotate. For this, the first electromagnet is fixed at the compressor 10.

The first electromagnet 140 should be installed closer to the first rotation disk 130a in order that it may affect well a strong magnetic force to the first rotation disk 130a.

The first pulley 150 is disposed between the first rotation disk 130a and the first electromagnet 140 and is connected by way of a first bearing 151 and installed on the rotary shaft 110, and a first belt groove 152 is formed on an outer rim surface covering the first electromagnet 140.

Since the first pulley 150 is installed on the rotary shaft 110 by way of a the first bearing 151, when the engine 20 is stopped, and the motor 30 is driven in a state that the first pulley 150 is connected with the pulley at the side of the engine 20 and the belt, the first pulley 150 can stay stopped, while being not restricted by the rotary shaft 110,

The first pulley 150 is positioned between the first rotary disk 130a and the first electromagnet 140 and is spaced apart by a certain interval between the first rotary disk 130a and the first electromagnet 140. At this time, when a magnetic force is generated at the first electromagnet 140, the first rotation disk 130a is attracted toward the first electromagnet 140 and becomes closer to the first rotation disk 130a. In a state that the first rotation disk 130a is closely contracted, for example when the engine 20 connected by way of a belt is driven, the first pulley 150 rotates and allows the first rotation disk 130a coming into close contact with it to rotate, the compressor 10 connected with the rotary shaft 110 can be driven.

The first pulley 150 is configured to be thin enough to be disposed between the first rotation disk 130a and the first electromagnet 140, and at the outer rim portion of which is formed a first belt groove 152 covering the first electromagnet 140 and for example being connected with the pulley at the side of the engine 20 by way of the belt.

The fixing disk 160 is positioned at the side of the second rotation disk 130b and is connected and installed on the rotary shaft 110 by way of the second bearing 161.

Since the fixing disk 160 is connected with a cable for the purpose of supplying an electric power to the second electromagnet 170 while engaging the second electromagnet 170, it should not rotate. For this, it is installed on the rotary shaft 110 by way of the second bearing 161, in other words, it is possible to keep a stopped state since the fixing disk 160 is not restricted by means of the second bearing 161 even when the rotary shaft 110 rotates.

The second electromagnet 170 is positioned at the side of the second rotation disk 130b and is fixed at the fixing disk 160. Since a cable is to connected to the second electromagnet 170 for the purpose of supplying an electric power to it, it should not rotate. For this, it is fixed at the fixing disk 160.

It is preferred that the second electromagnet 170 is installed closer to the second rotation disk 130b in order that a strong magnetic force may well affect it.

The second pulley 180 is positioned between the second rotation disk 130b and the second electromagnet 170 and is connected and installed on the rotary shaft 110 by way of a third bearing 181. The second belt groove 182 is formed at an outer rim surface covering the second electromagnet 170.

Since the second pulley 180 is installed on the rotary shaft 110 by way of the third bearing 181, for example when the motor 30 is stopped and the engine 20 is driven in a state that the second pulley 180 is connected to the pulley at the side of the motor 30 by way of a belt, it is possible to keep a stopped state while being not restricted by means of the rotary shaft 110.

The second pulley 180 is disposed between the second rotation disk 130b and the second electromagnet 170 and is spaced apart by a certain distance between the second rotation disk 130b and the second electromagnet 170. At this time, when a magnetic force is generated at the second electromagnet 170, the second rotation disk 130b is attracted toward the to second electromagnet 170 and comes into close contact with the second pulley 180. In a state that the second rotation disk 130b is in close contact, for example, when the motor 30 connected by way of a belt is driven, the second pulley 180 rotates and allows the closely contacting second rotation disk 130b rotate, so the compressor 10 connected with the rotary shaft 110 is driven.

The second pulley 180 is configured to be thin enough to be disposed between the second rotation disk 130b and the second electromagnet 170, and at an outer rim surface of which is formed a second belt groove 182 covering the second electromagnet 170 while for example being connected with the pulley at the side of the motor 30 by way of a belt.

It is preferred that an interval of 0.01˜1.8 mm is provided between the surfaces contacting with the first rotation disk 130a and the first pulley 150 and between the surfaces contacting with the second rotation disk 130b and the second pulley 180.

At this time, it is preferred that protrusions might be formed between the surfaces contacting with the first rotation disk 130a and the first pulley 150 and between the surfaces contacting with the second rotation disk 130b and the second pulley 180 for the purpose of preventing slipping during rotations in a closely contacted state.

According to the present invention, for example, in a state that the engine 20 of the vehicle is driven, when the air conditioner system starts, an electric power is supplied to the first electromagnet 140, and a magnetic force is generated, and as a result of it, the first rotation disk 130a comes into close contact with the first pulley 150. Since the first pulley 150 is connected with the pulley at the side of the engine 20 by way of a belt, it rotates by means of a rotational force of the engine 20 and enables the first rotation disk 130a, the plate spring 120 and the rotary shaft 110, so the compressor 10 is driven.

In addition, when it is needed to drive the air conditioner system of a vehicle in a state that the vehicle is stopped for a long time, and the engine 20 is stopped, the motor 30 is driven by supplying an external electric power. In the above mentioned manner, when the air conditioner system is driven in a state that the motor 30 of the vehicle is driven, a magnetic force is generated as an electric power is supplied to the second electromagnet 170, and then the second rotation disk 130b comes into close contact with the second pulley 180.

Since the second pulley 180 is connected with the pulley at the side of the motor 30 by way of a belt, it rotates by means of a driving force of the motor 30 and enables the second rotation disk 130b, the plate spring 120 and the rotary shaft 110 for thereby driving the compressor 10.

Therefore, according to the present invention, it is possible to make a driving force be selectively supplied from the engine 20 and the motor 30 in such away to connect a double clutch 100 to the compressor 10, so it is possible to drive the air conditioner system using the engine 20 and the motor 30 by providing one compressor 10, and the structures of the vehicle and the air conditioner system can be improved, and the manufacture cost can be reduced.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A double cutch for a vehicle compressor, comprising:
a rotary shaft which is axially engaged to a compressor;
a plate spring which is engaged on the rotary shaft and is bent in forward and backward directions;
first and second rotation disks which are engaged to the front side and the rear side of the plate spring and have magnetized force;
a first electromagnet which is positioned at the side of the first rotation disk and is fixed at the compressor;
a first pulley which is positioned between the first rotation disk and the first electromagnet and is installed on the rotary shaft by way of a first bearing and has a first belt groove at an outer rim surface covering the first electromagnet;
a fixing disk which is positioned at the side of the second rotation disk is and is installed on the rotary shaft by way of a second bearing;
a second electromagnet which is positioned at the side of the second rotation disk and is engaged to the fixing disk; and
a second pulley which is positioned between the second rotation disk and the second electromagnet and is installed on the rotary shaft by way of a third bearing and has a second belt groove at an outer rim surface covering the second electromagnet.

2. A double clutch for a vehicle compressor according to claim 1, wherein an interval of 0.01˜1.5 mm is formed between the surfaces contacting with the first rotation disk and the first pulley and between the surfaces contacting with the second rotation disk and the second pulley.
